(19) United States
(12) Patent Application Publication
(10) Pub. No.: US 2002/0187804 A1
(43) Pub. Date: Dec. 12, 2002

(54) Wireless terminals and methods that can acquire a CDMA system while continuing to receive paging messages from an AMPS system

(76) Inventors: Murali Narasimha, Raleigh, NC (US); Essam Sourour, Cary, NC (US); Wail M. Refai, Apex, NC (US)

Correspondence Address: MYERS BIGEL SIBLEY & SAJOVEC, PO BOX 37428, RALEIGH, NC, 27627, US

(21) Appl. No.: 09/844,400

(22) Filed: Apr. 27, 2001

(51) Int. Cl. H04M 1/00

(52) U.S. Cl. 455/552; 455/553; 455/550

(57) ABSTRACT

Multiple-mode AMPS system/CDMA system wireless terminals attempt to acquire the CDMA system independent of receiving a Global Action (GA) overhead message from the AMPS system, while continuing to receive paging messages from the AMPS system. In response to the attempt being successful, the multiple-mode AMPS/CDMA wireless terminals transition from the AMPS system to the CDMA system. The attempting may be performed by receiving paging messages from the AMPS systems during spaced apart time intervals and attempting to acquire the CDMA system between the spaced apart time intervals. Specifically, a paging message may be received from a first frame of an AMPS control channel of the AMPS system and an AMPS sleep mode is entered thereafter. CDMA pilot acquisition data may be accumulated during the AMPS sleep mode. These operations may be repeated for second and subsequent frames of the AMPS control channel, until sufficient CDMA pilot acquisition data is accumulated to acquire the CDMA pilot and/or the CDMA System ID (SID) field.

### BACKGROUND OF THE INVENTION

This invention relates to wireless communications terminals and operation methods, and more particularly to multiple-mode wireless terminals that can operate under both an Advanced Mobile Phone Service (AMPS) and a Code Division Multiple Access (CDMA) system.

Wireless communications systems and methods are widely used for voice and/or data communications. Wireless communications systems and methods include CDMA systems that operate, for example, under standards TIA/EIA-95 and IS-2000 and non-CDMA systems, referred to herein as AMPS systems, that operate, for example, under standards EIA/TIA/IS-3, TIA/EIA/IS-91 and TIA/EIA/IS-136. In CDMA systems, each user is assigned a unique code, and transmissions to and from wireless terminals are spread in parallel over a common band of frequencies. CDMA systems also have a dedicated pilot signal that is code spread over the channel bandwidth. AMPS systems can include one or more analog or digital control channels, and at least one traffic channel.

Multiple-mode AMPS/CDMA wireless terminals, i.e. wireless terminals that can operate with both AMPS (i.e. non-CDMA) and CDMA systems, are known. For example, wireless terminals operating according to standards IS-95 and IS-2000 may operate on both CDMA systems, as well as AMPS systems. As used herein, the term “wireless terminal” includes cellular radiotelephones with or without a multi-line display; Personal Communications System (PCS) terminals that may combine a cellular radiotelephone with data processing, facsimile and/or data communications capabilities; Personal Data Assistants (PDA) that can include a radiotelephone, pager, Internet/intranet access, Web browser, organizer, calendar and/or a global positioning system (GPS) receiver; and/or conventional laptop and/or palmtop receivers or other appliances, which include a radio frequency transceiver.

### SUMMARY OF THE INVENTION

According to embodiments of the present invention, multiple-mode AMPS system/CDMA system wireless terminals and operating methods attempt to acquire the CDMA system independent of receiving a Global Action (GA) overhead message from the AMPS system, while continuing to receive paging messages from the AMPS system. In response to the attempting being successful, embodiments of multiple-mode AMPS/CDMA wireless terminals and operating methods transition from the AMPS system to the CDMA system. In yet other embodiments, attempting to acquire the CDMA system independent of receiving the GA overhead message while continuing to receive paging messages is performed by receiving paging messages from the AMPS systems during spaced apart time intervals and attempting to acquire the CDMA system between the spaced apart time intervals. In still other embodiments, a word on the control channel is received from a first frame of an AMPS control channel of the AMPS system and an AMPS sleep mode is entered thereafter. CDMA pilot data is accumulated during the AMPS sleep mode. These operations of receiving a paging message, entering an AMPS sleep mode and accumulating CDMA pilot data may be repeated for second and subsequent frames of the AMPS control channel, until sufficient CDMA pilot acquisition data is accumulated to acquire the CDMA pilot and/or the CDMA System ID (SID) field.

### BRIEF DESCRIPTION OF THE DRAWINGS

FIG. 1 is a schematic diagram illustrating multiple-mode AMPS/CDMA wireless terminals and operating methods according to embodiments of the present invention.

FIG. 2 is a block diagram of multiple-mode AMPS/CDMA wireless terminals according to embodiments of the present invention.

FIGS. 3-7 are flowcharts of AMPS-to-CDMA transitions according to embodiments of the present invention.

FIG. 8 illustrates an example of a forward control channel datastream for an AMPS system.

FIG. 9 is a flowchart of determining whether a CDMA acquisition attempt is successful according to embodiments of the invention.

FIG. 10 illustrates a detailed timing diagram of a synchronization channel message for a CDMA system.

FIGS. 11 and 12A-12B are flowcharts of other AMPS-to-CDMA transitions according to embodiments of the present invention.

### DETAILED DESCRIPTION OF THE INVENTION

The present invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

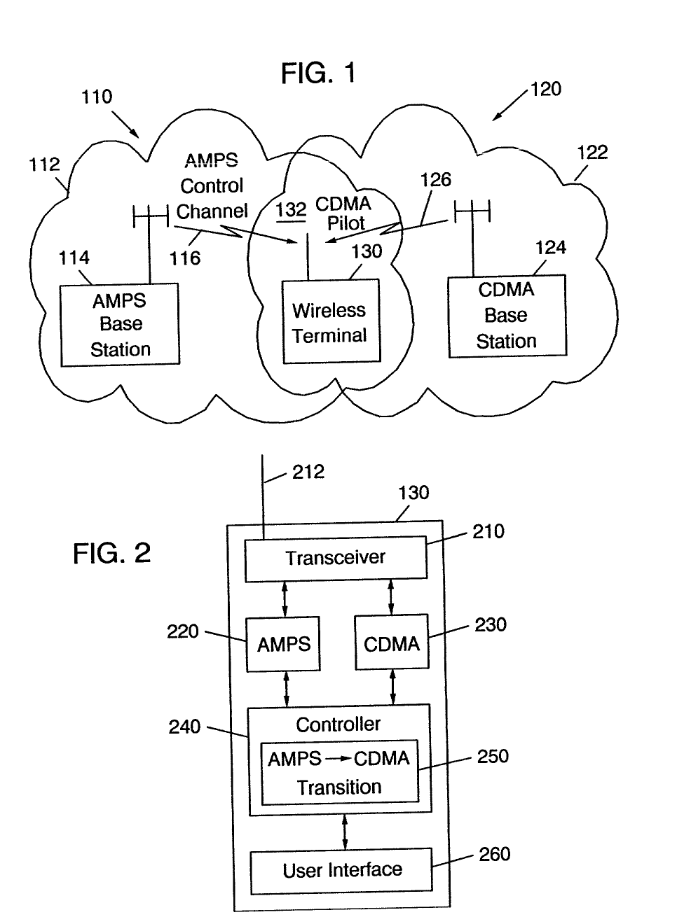

FIG. 1 is a schematic diagram illustrating multiple-mode AMPS/CDMA wireless terminals and methods according to embodiments of the present invention that operate under an AMPS system and a CDMA system, also referred to herein as an AMPS wireless communications system and a CDMA wireless communications system, respectively. More specifically, referring to FIG. 1, an AMPS system 110 that can operate under one or more of the above cited or other standards employs one or more cells to cover an AMPS system geographic area 112 using one or more AMPS base stations 114. One or more wireless terminals 130 acquire the AMPS system 110 using one or more AMPS control channels 116 that are broadcast from the AMPS base stations 114, as will be described in detail below.

Still referring to FIG. 1, a CDMA system 120 includes one or more CDMA cells that operate over a CDMA geographic area 122 using one or more CDMA base stations 124. The CDMA system is acquired by one or more wireless terminals 130 by receiving a CDMA pilot 126 that is broadcast from the CDMA base stations 124 to the wireless terminals 130. The design and operation of AMPS systems 110 and CDMA systems 120 are well known to those having skill in the art and need not be described further herein.

As shown in FIG. 1, the geographical area 112 of the AMPS system 110 and the geographical area 122 of the CDMA system 120 may overlap, as indicated at an overlap area 132. When a wireless terminal 130 is located in the overlap are 132, as shown in FIG. 1, it may be desirable for the wireless terminal 130 to transition from operating under the AMPS system 110 to operating under the CDMA system 120, because the CDMA system 120 can offer longer battery life, higher capacity and/or better voice quality.

When the CDMA and AMPS systems 120 and 110, respectively, in a particular region are owned and operated by the same carrier, it is known that the carrier can benefit by informing the wireless terminals 130 that are using the AMPS system 110 that the CDMA system 120 is potentially available. Pursuant to standard TIA/EIA/IS-95-B, entitled Mobile Station-Base Station Compatibility Standard for Dual-Mode Spread Spectrum Systems, Section 3.1, Oct. 31, 1998, a Global Action (GA) overhead message, with the CDMA_AVAIL bit set to 1, is used in the AMPS control channel 110 to indicate to a wireless terminal 130 that CDMA service is available. If this message is received on the AMPS control channel 116, the wireless terminal 130 can begin a search for a CDMA pilot 126 and try to acquire CDMA service.

However, it is not mandatory for the AMPS carrier to inform the wireless terminal 130 of the availability of CDMA service. For example, if the AMPS and CDMA systems 110 and 120, respectively, belong to different carriers, it is known that the GA overhead message that was described above may not be used. Moreover, it is also known that carriers may not use the GA overhead message as described above, even if they have control of both the AMPS systems and the CDMA systems in a given geographical region. Embodiments of the present invention can provide wireless terminals and operating methods that can attempt to acquire a CDMA system independent of receiving a GA overhead message from the AMPS system 110.

Prior to describing additional details of wireless terminals and operating methods according to embodiments of the present invention, a general discussion of system acquisition will be provided. System acquisition refers to obtaining and demodulating signals from a base station on a specific channel, so as to obtain system information that is used for synchronization. System acquisition brings the wireless terminal 130 to a state in which it can originate and receive wireless communications. The channel which is to be demodulated generally depends on whether acquisition is being made for the AMPS system 110 or the CDMA system 120. Furthermore, the manner in which synchronization is achieved, and the system information that is transmitted generally is dependent on whether an AMPS system 110 or CDMA system 120 is being acquired.

System acquisition of the AMPS system 110 can be based directly on FM radio principles. For example, 21 AMPS control channels 116 may be available for each of System A and System B. A wireless terminal 130 measures a Received Signal Strength Indication (RSSI) for all of the AMPS control channels and can pick the two signals with the highest RSSI. It then attempts to synchronize with the channel with the highest RSSI. If this attempt fails, then the wireless terminal 130 tries to synchronize with the second AMPS control channel. If synchronization fails, the wireless terminal 130 proceeds to scan the other sub-band. Channel validation then is performed to determine if the signals are control channels or voice channels. If both are voice channels, the wireless terminal 130 scans the other band. Otherwise, system parameter information is obtained from the AMPS control channel 116. The wireless terminal 130 continues to listen to the AMPS control channel 116 as long as the AMPS system 110 is being used for service. Messages to the wireless terminal 130, such as paging, alert and overhead messages, are received at the wireless terminal 130 from the AMPS base stations 114 via the AMPS control channel 116. Acquisition is described in more detail in the AMPS standards that were cited above, and need not be described in further detail herein.

In contrast, CDMA systems 120 include a pilot signal 126 that is code spread over a channel bandwidth, for example of 1.25 MHz. The pilot signal may be a 2¹⁵ bit long pseudo-noise code that is transmitted continuously. All CDMA base stations 124 may transmit the same code. However, in order to allow the base stations 124 to be distinguished, base stations which can potentially interfere with each other can transmit the code with an offset of 64×n bits, where n is greater than or equal to 2.

CDMA terminals may use an array of three or more receivers known as RAKE receivers, including fingers which demodulate or despread respective signals corresponding to respective multipaths. CDMA terminals can combine the demodulated multipaths after matching the delays to obtain a stronger signal that can be more resistant to fast fading. One or more of the fingers may be used as a pilot searcher. It can constantly search for different pilots 126 and their multipaths. The pilot searcher can direct the other fingers to various pilots and their multipaths, as desired. The rake fingers then can be programmed to demodulate the synchronization channel corresponding to the pilot obtained. The synchronization channel message includes the pilot pseudo-noise offset. The chip duration in IS-95 and the single carrier version of IS-2000 is 0.814 microseconds. The duration of the entire pilot code is 26.67 ms (2¹⁵÷1.2288×10⁶). Thus, 26.67 ms can be the maximum length of time an attempted search for a CDMA pilot 126 may take under these standards.

After finding a usable CDMA system, the wireless terminal 130 can search for a more preferable CDMA system. In particular, the searcher may be used to find better pilots. A list of pilots to search for may be provided to the searcher. Alternatively, a pilot searcher can try several segments of the pseudo-noise code to find matches with pilots and store those results. One of the rake receiver fingers can be programmed to receive these pilots one after the other and decode the synchronization channels to obtain system information corresponding to the pilot. This may be done while service is still available on the initially acquired CDMA system.

In order to acquire the CDMA system 120 when operating under the AMPS system 110, the wireless terminal 130 may need to periodically search for CDMA pilots 126 in the appropriate band, by activating the pilot searcher. During the search, the wireless terminal 130 generally will be unable to receive the AMPS control channel 116. If a wireless communication is initiated by the wireless terminal 130 while the search is in progress, the search may be terminated, and the communication may be completed on the AMPS system 110. However, since the wireless terminal 130 generally will not be receiving the AMPS control channel 116 during the search for the CDMA pilot 126, there is a possibility that paging messages that are sent on the AMPS control channel 116 by the AMPS base station 114 will be missed. Missing pages may lead to missed incoming AMPS wireless communications and/or failure of other AMPS features. If the CDMA pilot 126 is weak, and the wireless terminal 130 is configured to periodically search for the CDMA pilot 126 while operating under the AMPS system 110, this may cause an unacceptably large number of missed pages. Wireless terminals 130 and operating methods according to embodiments of the present invention can reduce or eliminate the possibility of missed pages on the AMPS control channel 116, and thereby allow improved performance while transitioning from the AMPS system 110 to the CDMA system 120.

FIG. 2 is a block diagram of multiple-mode AMPS/CDMA wireless terminals 130 according to embodiments of the present invention. The wireless terminal 130 can include one or more radio frequency transceivers 210 coupled to one or more antennas 212. An AMPS subsystem 220 and a CDMA subsystem 230 including, for example, respective TDMA and CDMA baseband processors, can operate as interfaces between the transceiver 210 and a controller 240, to send, receive and/or process AMPS and CDMA control and communications messages, as appropriate. A user interface 260 also may be provided. The user interface can include displays, keyboards, microphones, speakers and/or other conventional elements. The design and operation of the elements of a multiple-mode AMPS/CDMA wireless terminal 130 as described in this paragraph are well known to those having skill in the art and need not be described in further detail. Moreover, it will be understood by those having skill in the art that elements of the transceiver 210, the AMPS subsystem 220, the CDMA subsystem 230, the controller 240 and the user interface 260 may be integrated with one another.

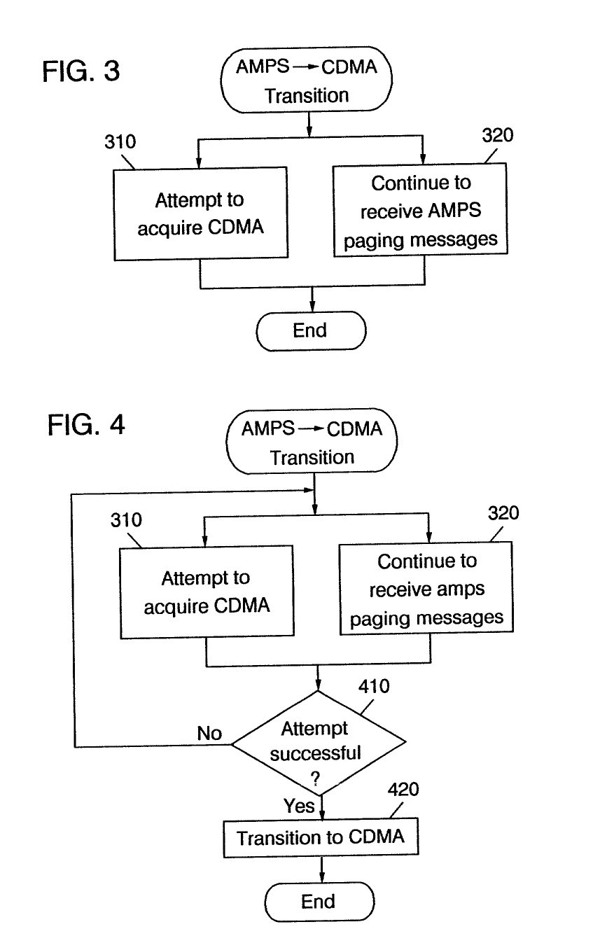

Still referring to FIG. 2, multiple-mode AMPS/CDMA wireless terminals and operating methods according to embodiments of the invention also include an AMPS-to-CDMA transition Block 250. AMPS-to-CDMA transition Block 250 according to embodiments of the present invention can reduce or eliminate the likelihood of missed pages on the AMPS control channel 116, while attempting to acquire the CDMA pilot 126. Various embodiments of AMPS-to-CDMA transition 250, according to embodiments of the invention, now will be described in connection with the flowcharts of FIGS. 3-9.

Referring now to FIG. 3, embodiments of AMPS-to-CDMA transition blocks, such as Block 250 of FIG. 2, for multiple-mode AMPS/CDMA wireless terminals, attempt to acquire the CDMA system 120 at the dual mode AMPS/CDMA wireless terminal 130, independent of receiving a Global Action (GA) overhead message from the AMPS system 110 at the wireless terminal 130, at Block 310, while continuing to receive paging messages for the dual mode AMPS/CDMA wireless terminal from the AMPS system 110 over the AMPS control channel 116, at Block 320. Referring now to FIG. 4, according to other embodiments, if the attempt to acquire the CDMA system at Block 310 is successful at Block 410, then the dual mode AMPS/CDMA wireless terminal 130 is transitioned from the AMPS system 110 to the CDMA system 120, at Block 420.

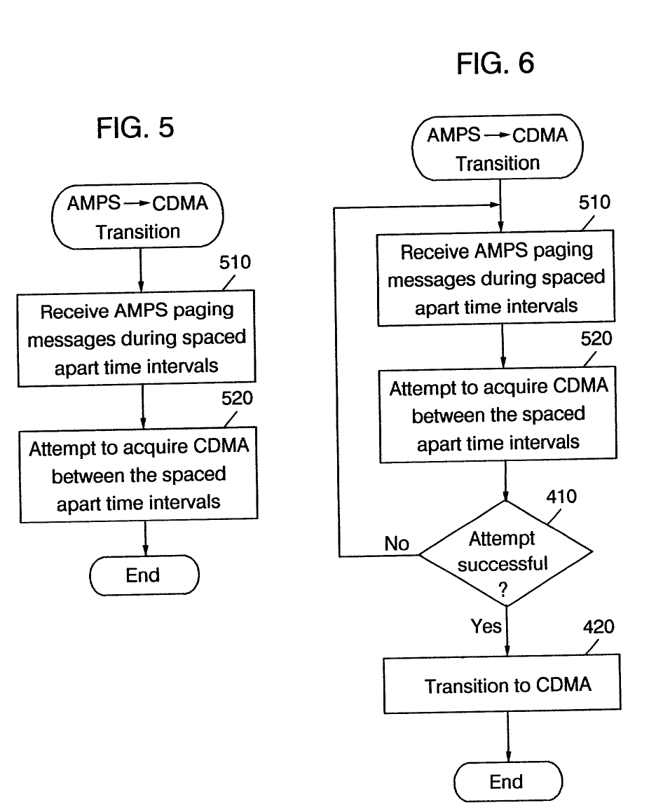

Referring now to FIG. 5, other embodiments of AMPS-to-CDMA transition 250 receive AMPS paging messages for the dual mode AMPS/CDMA wireless terminal 130 from the AMPS control channel 116 at the dual mode AMPS/CDMA wireless terminal 130 during spaced apart time intervals, at Block 510. At Block 520, attempts are made to acquire the CDMA system 120 at the dual mode AMPS/CDMA wireless terminal 130 between the spaced apart time intervals. As shown in FIG. 6, in other embodiments, if the attempt is successful (Block 410), then the transition is made to CDMA system (Block 420).

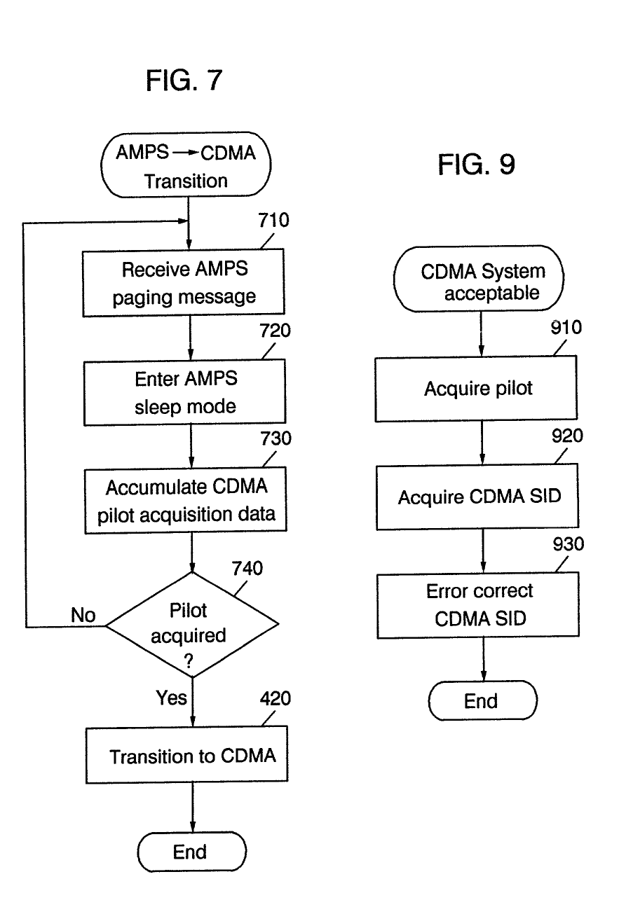

Referring now to FIG. 7, according to other embodiments, paging messages are received from the AMPS system 110 at the wireless terminal 130 during spaced apart time intervals (Block 510 of FIGS. 5 and 6) as follows: At Block 710, a paging message is received from a first frame of an AMPS control channel 116 of the AMPS system 110 at the dual mode AMPS/CDMA wireless terminal 130. Then, at Block 720, an AMPS sleep mode is entered. Attempting to acquire the CDMA system 120 between the spaced apart time intervals (Block 520 of FIGS. 5 and 6) may be embodied by accumulating CDMA pilot acquisition data during the AMPS sleep mode, at Block 730. Then, at Block 740, if the pilot has been acquired, the wireless terminal 130 transitions to CDMA at Block 420. If the pilot is not acquired at Block 740, then the receiving an AMPS paging message (Block 710), entering AMPS sleep mode (Block 720), and accumulating CDMA pilot acquisition data (Block 730) is repeated for second and subsequent frames of the AMPS control channel 116, until the pilot is acquired at Block 740.

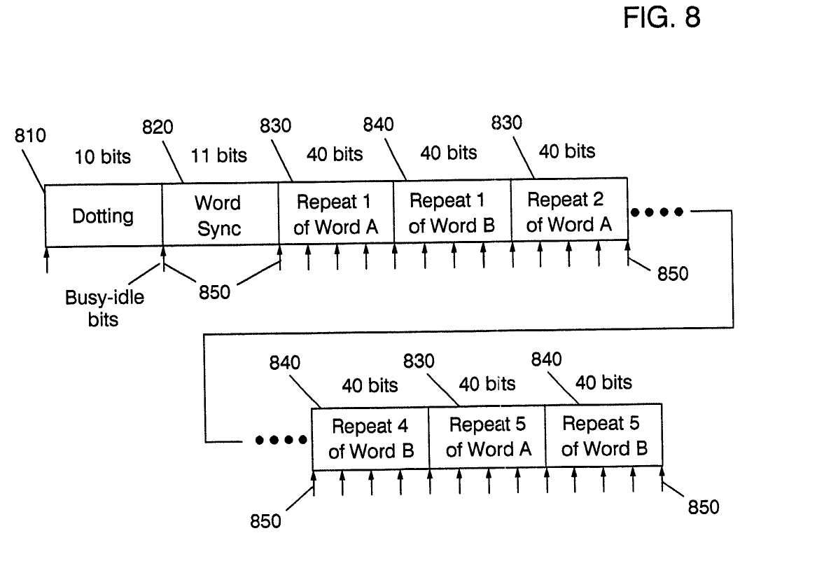

Additional embodiments of FIGS. 5-7 now will be described. These embodiments can use the structure of the datastream of the AMPS control channel 116, also referred to herein as the AMPS forward control channel, to reduce or eliminate the possibility of missing paging messages on the AMPS control channel 116 at the wireless terminal 130. An example of a forward control channel datastream according to EIA/TIA-533A is illustrated in FIG. 8. The 10-bit dotting sequence 810 and the 11-bit word synchronization sequence 820 are used by the wireless terminal 130 to achieve synchronization with the incoming stream. The datastream includes three streams that are time multiplexed: stream A, stream B and a busy-idle stream. Information is transmitted in fixed length (for example 40-bit) words. Wireless terminals 130 with the least significant bit of their mobile identification number equal to 0 may only receive information in the “A” words 830, and those with the least significant bit equal to 1 may only receive information in the “B” words 840. The busy-idle stream includes busy-idle bits 850. If a busy-idle bit is equal to 0, the reverse control channel from the wireless terminals 130 to the AMPS base stations 114 is busy, and if it is 1, the reverse control channel is idle. Each word is 40 bits long, including 28 bits of content and a parity check, and is repeated five times, as shown in FIG. 8. The five repetitions of the 40-bit words are referred to as a “word block”. Each wireless terminal 130 demodulates either the A or B word, but not both, for example using the AMPS subsystem 220 of FIG. 2. Furthermore, if the word is received correctly during a first repeat, there is no need to receive it again. When in the idle mode, the mobile station sleeps during the remaining duration of the word block. The datastream is transmitted at 10 kilobits/sec and the duration of the entire datastream shown in FIG. 8 is 46.3 ms.

Referring back to FIG. 7, according to embodiments of the invention, if a CDMA system 120 is to be acquired, the remainder of the sleep mode (Block 720) after correctly receiving the appropriate word (Block 710) on the analog forward control channel of FIG. 8 is used to acquire CDMA pilots (Block 730). Thus, the wireless terminal 130 switches context between the analog demodulation and the CDMA pilot searcher, for example, by activating the CDMA subsystem 230 and deactivating the AMPS subsystem 220.

As noted above, the duration of a CDMA pilot sequence may be 26.67 ms. The wireless terminal 130 makes one or more sojourns from the AMPS control channel 116 in order to acquire the CDMA pilot 126, while still returning to the AMPS control channel 116 to receive its word. In particular, the wireless terminal 130 receives the appropriate word on the AMPS control channel 116, at Block 710, enters AMPS sleep mode at Block 720, and starts CDMA pilot acquisition at Block 730. Until the point in time when the wireless terminal 130 needs to return to the AMPS control channel 116, it can receive the CDMA pilot acquisition data 730 at the designated frequency and buffer it. The wireless terminal then returns to the AMPS control channel 116 at Block 710, assuming the pilot is not acquired. When returning to the AMPS control channel 116 at Block 710, the accumulated CDMA pilot acquisition data at Block 730 can be used to determine if there is a CDMA pilot at that frequency. If there is one, it can be acquired in the next sojourn.

One technique for determining if there is a CDMA pilot is described in a publication by coinventor Sourour entitled Direct Sequence Spread Spectrum Acquisition With Fast Search and Parallel Verification in a Multipath Fading Channel, Proceedings of the First International Symposium on Wireless Personal Multimedia Communications, November 1998, the disclosure of which is hereby incorporated herein by reference. It will be understood that other techniques may be used with embodiments of the present invention to determine if there is a CDMA pilot.

Once the CDMA pilot is acquired at Block 740, the wireless terminal 130 need not continue to listen to the AMPS control channel 116. Rather, at Block 420, it can receive the synchronization channel messages and can continue with remaining initialization procedures, for example, that are described in TIA/EIA/IS-95B. If the CDMA system 120 is discovered to be unacceptable, for example due to unacceptable roaming parameters, overload or other reasons, the wireless terminal can then return to reacquire the AMPS control channel 116. Alternatively, the AMPS control channel 116 can be continued to be listened to until an acceptable CDMA system 120 is acquired and/or fully initialized.

In some embodiments that were described above, an attempt to acquire a CDMA system (Block 410) or an attempt to acquire the pilot (Block 740) may be successful, only to find later that the CDMA system is not acceptable. For example, the following scenario is possible: the wireless terminal 130 can acquire the pilot (Block 410 or 740), transition to CDMA (Block 420), receive the complete CDMA synchronization message, for example nine frames of 26.666 ms each, and then using the System ID (SID) in the synchronization channel message, can determine that the system is not acceptable. The system may not be acceptable because the wireless terminal 130 can maintain information about which systems and networks it is permitted to use. This encoding of carrier preferences is called a “preferred roaming list”, as described in TIA/EIA/IS-683-A, and is analogous to the intelligent roaming database of IS-136 systems. An unacceptable system may be one that is not in the wireless terminal's preferred roaming list.

Embodiments of the invention can reduce or prevent the likelihood of acquiring the CDMA pilot, only to later find that the CDMA system is not acceptable. An example of these embodiments is shown in FIG. 9. Embodiments of FIG. 9 may be used as part of the test of whether an attempt to acquire the CDMA system is successful (Block 410 of FIGS. 4 or 6) or as further processing in the decision of whether the pilot has been acquired (Block 740 of FIG. 7).

In general, in FIG. 9, sufficient CDMA pilot acquisition data is accumulated to acquire the CDMA pilot and the CDMA SID field. In particular, referring to FIG. 9, the CDMA pilot 126 is acquired at Block 910. At Block 920, the CDMA SID also is acquired, and at Block 930, the CDMA SID is error corrected. If the CDMA SID is acquired and error corrected successfully, and it is determined that the CDMA SID is acceptable, the transition to CDMA (Block 420) performed. Thus, the possibility of the wireless terminal 130 acquiring the pilot, leaving the AMPS mode and later determining that the CDMA system is not acceptable can be reduced or eliminated.

Additional details of determining whether an attempt to acquire the CDMA system are successful according to embodiments of FIG. 9, by pilot buffering with synchronization channel look-ahead for the SID, now will be described. In standards IS-95 and IS-2000, the synchronization channel message body is 170 bits. Its contents are shown in the following Table:

TABLE

| Field | Length (bits) |
|---|---|
| MSG_TYPE | 8 |
| P_REV | 8 |
| MIN_P_REV | 8 |
| SID | 15 |
| NID | 16 |
| PILOT_PN | 9 |
| LC_STATE | 42 |
| SYS_TIME | 36 |
| LP_SEC | 8 |
| LTM_OFF | 6 |
| DAYLT | 1 |
| PRAT | 2 |
| CDMA_FREQ | 11 |

The message body shown in the above Table is preceded by an 8-bit message length field and is followed by a 30-bit Cyclic Redundancy Check (CRC) to form the synchronization channel message. The synchronization channel frame in IS-95 and IS-2000 includes 32 bits: one start-of-message bit followed by 31 bits of the synchronization channel message. The synchronization channel frame is transmitted over 26.67 ms. Three consecutive synchronization channel frames form a synchronization channel superframe that is 80 ms long. The synchronization channel is transmitted at 1200 bps.

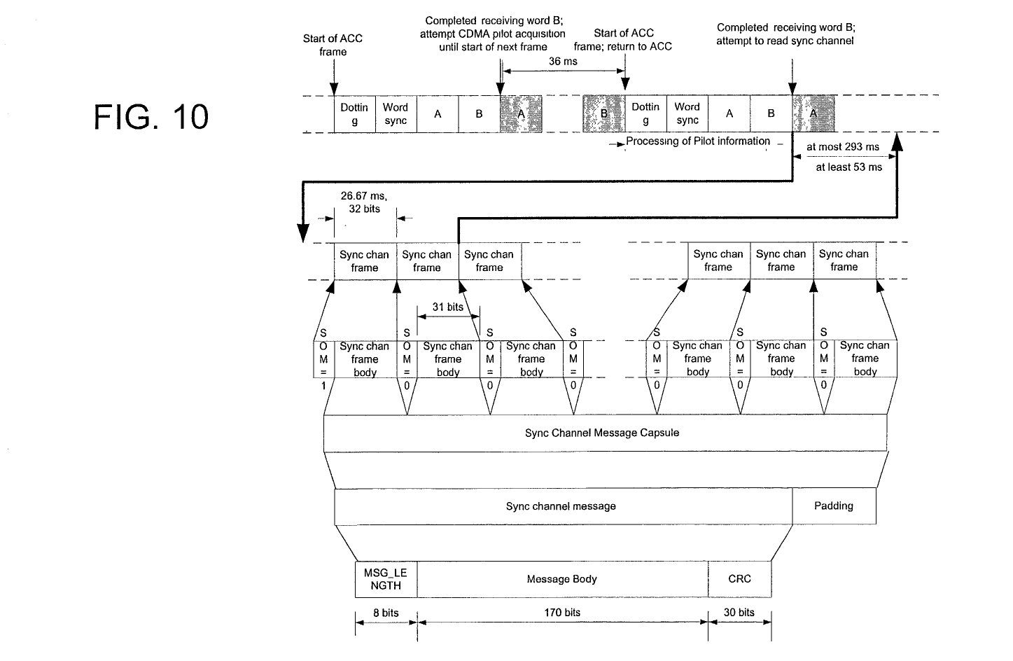

FIG. 10 is a detailed timing diagram for the synchronization channel message shown in the above Table. As shown in FIG. 10, the 170+8+30 bits of the synchronization channel message is split into three units of 93 bits each with 0 padding (80 bits). Each of the 93 bit units is formatted for transmission in a synchronization channel superframe as follows: Each of the 93 bit units is broken into three units of 31 bits each. A start-of-message bit is added to the front of each of the 31 bits and each of the resulting 32 bits that fits into a synchronization channel frame. Consequently, synchronization channel superframes (9 synchronization channel frames) are used to transmit the synchronization channel message.

However, in order for the wireless terminal 130 to decide that the CDMA system 120 is not desirable, it may not need to receive the entire synchronization channel message of FIG. 10. It may only need to receive enough synchronization channel frames until it reaches the SID field of the message. From the above Table, and from FIG. 10, it can be seen that the SID is transmitted during the second frame of the synchronization channel message. Thus, the wireless terminal 130 need only receive two frames of the 9 frame synchronization channel message to decide whether it needs to continue to listen to the remaining part of the synchronization channel message or to leave the CDMA pilot channel 126 and go back to the AMPS control channel 116. By performing synchronization channel look-ahead, considerable time and/or battery power can be saved.

Accordingly, referring again to FIG. 9, the CDMA pilot is acquired at Block 910. During the course of pilot acquisition at Block 910, the AMPS control channel 116 is continued to be listened to and the wireless terminal 130 still continues to operate under the AMPS system 110. The pilot continues to be acquired until the first two frames of the synchronization channel are acquired, so that the CDMA SID is acquired at Block 920. The received SID then is used to determine if service can be provided on the CDMA system 120. If no, then a transition to CDMA (Block 420) is not performed, and the AMPS paging message is continued to be received at Block 710. If yes, then the transition to CDMA (Block 420) is performed, and CDMA initialization is performed.

When the CDMA SID is acquired at Block 920 using a synchronization channel look-ahead described above, it will be understood that the SID may include an error therein. In particular, CDMA synchronization channel frames that were described in FIG. 10 do not include CRC bits. Only the full synchronization channel message has CRC bits at the end. Since it is desirable that the wireless terminal 130 make a decision on the SID after receiving only two frames as described above, the wireless terminal 130 may use a different technique to decide the validity of the synchronization channel frames before receiving the whole message. For example, the CDMA SID may be error corrected (Block 930) using a technique that is described in U.S. patent application Ser. No. 09/300,184 to Guey entitled Rate Detection Apparatus and Method for Variable Rate Speech Encoding, filed Apr. 27, 1999, the disclosure of which is hereby incorporated herein by reference in its entirety. This technique may be used in IS-95 to detect the validity of traffic channel frames at data rates of 1.2 and 2.4 kbps. According to embodiments of the present invention, this technique may be used for CDMA SID error correction at Block 930, without the need to wait to receive the CRC for the entire synchronization channel message. Other techniques also may be used.

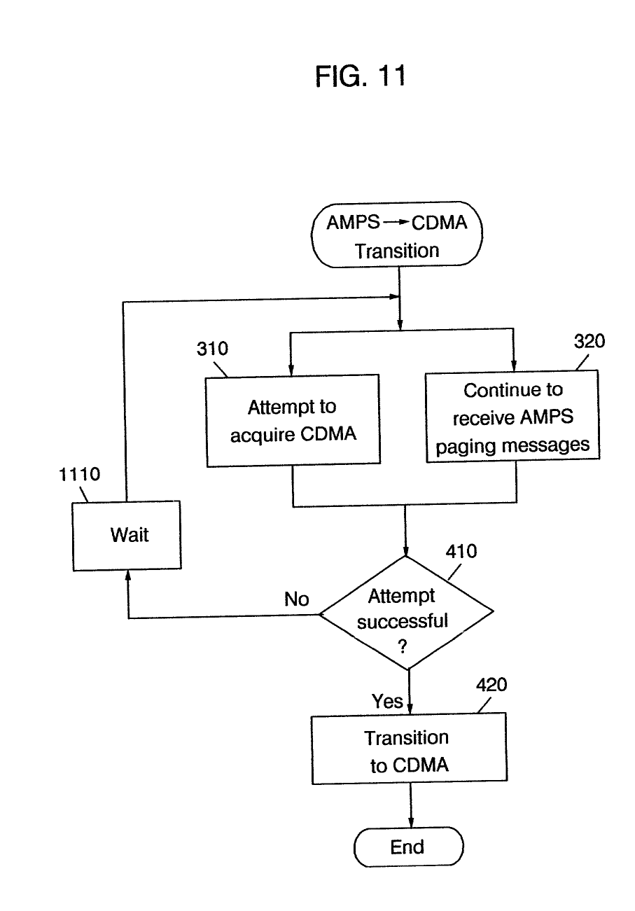

If attempts are made to acquire the CDMA system 120 according to the above-described embodiments during every AMPS control channel word, the battery power in the wireless terminal 130 may be drained excessively. Moreover, because the wireless terminal 130 generally changes location slowly relative to the locations of the AMPS base stations 114 and the CDMA base stations 124, it may be unnecessary to attempt to acquire the CDMA system 120 during every analog control channel word block. According to embodiments of the present invention as shown in FIG. 11, the spaced apart time intervals during which an attempt is made to acquire the CDMA system 120 may be increasingly spaced apart. In particular, as shown in FIG. 11, after a determination is made as to whether an attempt to acquire CDMA is successful at Block 410, embodiments of the invention can wait for a predetermined time (Block 1110) until a new attempts is made to acquire the CDMA system at Block 310. In some embodiments, the wait may be a constant time or a constant number of AMPS control channel words. In yet other embodiments of the invention, the wait time may increase with each cycle of operations. In still other embodiments, the wait time may increase until a predetermined maximum wait time is achieved, after which the maximum wait time is maintained. Accordingly, adaptive embodiments may be provided.

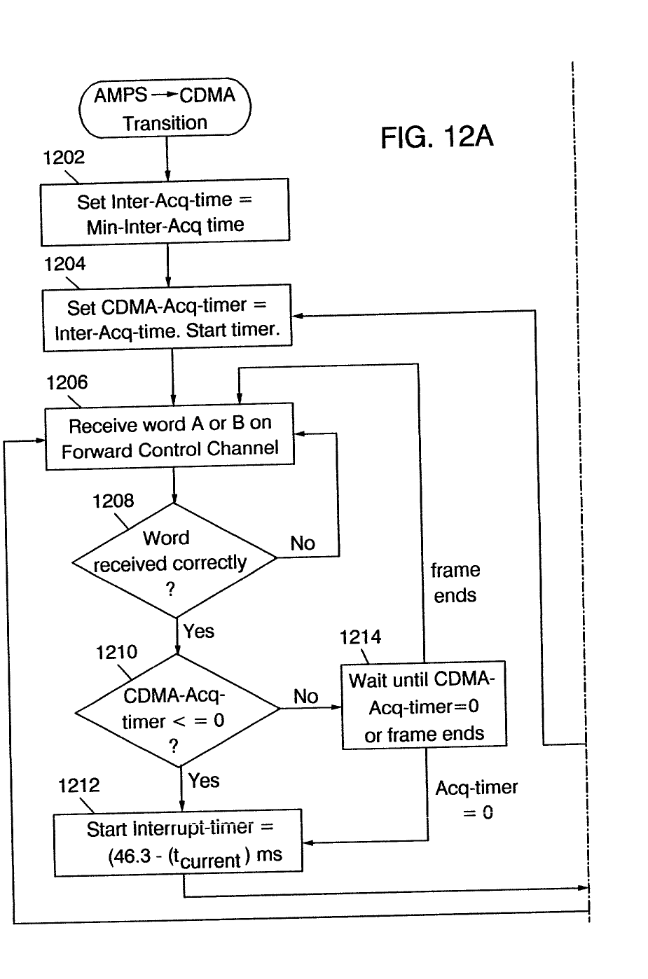

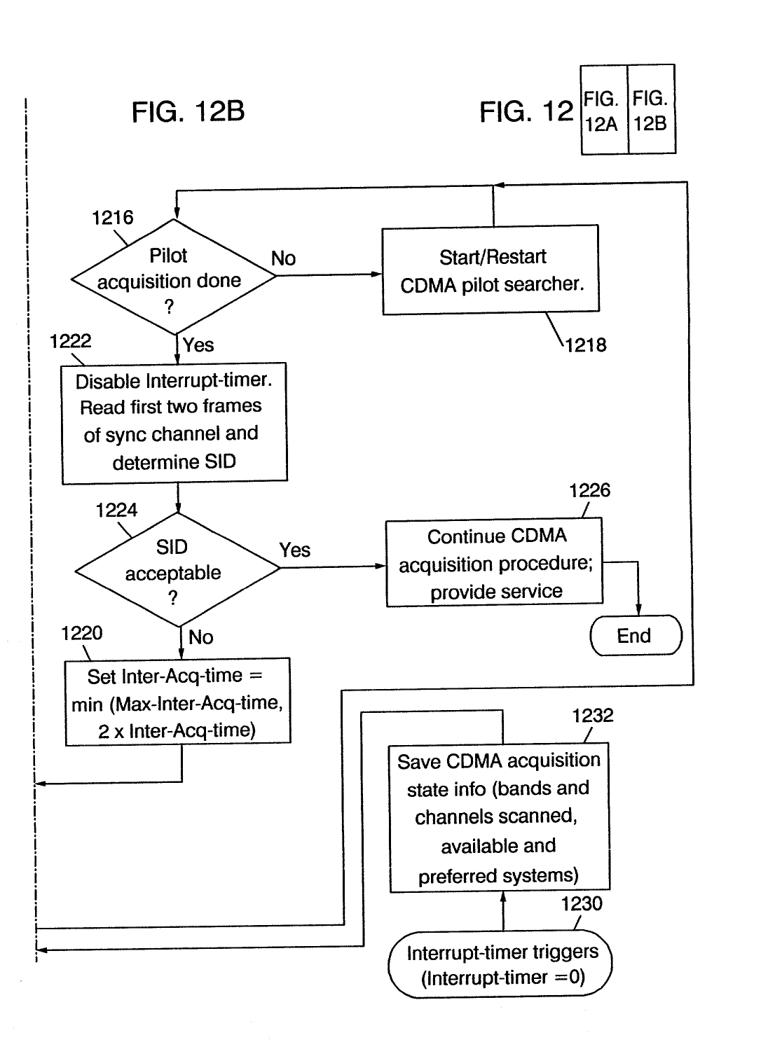

FIGS. 12A-12B, which when placed together as indicated form FIG. 12, are a flowchart illustrating embodiments of the present invention that include acquiring the CDMA SID (FIG. 9) and adjusting the wait time (FIG. 11). In order to control the time between successive acquisition attempts (Inter-Acq-time), two parameters are used: Min-inter-Acq-time and Max-inter-Acq-time. These parameters are used as bounding values for the duration between successive searches (Inter-Acq-time). For example, Min_inter-Acq-time may be set to one minute and Max_inter_Acq_time may be set to two hours. The Inter-Acq-time may be increased exponentially (for example, doubled) up to Max-inter-Acq-time. Thus, in an area where CDMA is unavailable, battery current need not be continuously wasted.

Referring to FIG. 12, the value of Inter-Acq-time is adjusted as follows: When a new geographical region is entered or when the wireless terminal 130 is powered on, Inter-Acq-time:=Min-inter-Acq-time (Block 1202). After CDMA acquisition is attempted unsuccessfully, Inter-Acq-time:=min(Max-inter-Acq-time, 2×Inter-Acq-time) (Block 1220).

At the beginning of operations, a CDMA-Acq-timer is started (Block 1204) to trigger after time Inter-Acq-time. The wireless terminal 130 tries to receive the appropriate word (A or B) on the AMPS forward control channel (Block 1206) and repeats this until the word is successfully received (Block 1208). If the timer has reached 0 (Block 1210), CDMA acquisition is started (Block 1212) after setting another timer (Interrupt-timer) to interrupt at the start of the next frame. The Interrupt-timer is used to return to the analog control channel at the start of a new frame. If the CDMA-Acq-time has not reached 0, the operations wait (Block 1214) until either the frame boundary is reached or until the CDMA-Acq-timer reaches 0.

In the former case, the reception of the next frame is started (Block 1216) and in the latter, CDMA acquisition is started (Block 1212) by starting/restarting the CDMA pilot searcher (Block 1218) until pilot acquisition is done (Block 1216), and reading the SID (Block 1222). If the SID is acceptable (Block 1224), service is provided (Block 1226) and operations are terminated. Otherwise, Inter-Acq-time is adjusted as was described above in connection with Block 1220, and the operations are restarted at Block 1204. During any part of this procedure, if the Interrupt-timer is triggered (Block 1230), the operations are interrupted (Block 1232) to start receiving the next frame on the analog control channel (Block 1206).

Thus, embodiments of FIG. 12 can provide that the wireless terminal 130 does not miss pages on the AMPS control channel 116 when a search for a CDMA pilot 126 is conducted. The CDMA search also may be adapted to the wireless environment so that if CDMA is not available in a given region, the time between successive searches can be increased exponentially up to a maximum limit. Battery current therefore need not be drained excessively.

The present invention has been described with reference to block diagram and flowchart illustrations of methods and wireless terminals according to embodiments of the invention. It will be understood that blocks of the block diagrams and/or flowchart illustrations, and combinations of blocks, can be implemented by computer program instructions. These computer program instructions may be provided to a processor of a general purpose computer, special purpose computer, or other programmable data processing apparatus to produce a wireless terminal, such that the instructions, which execute via the processor of the computer or other programmable data processing apparatus, create circuits, systems, subsystems or other structures for implementing the functions specified in the block diagram and/or flowchart block or blocks.

These computer program instructions may also be stored in a computer-readable memory that can direct a wireless terminal to function in a particular manner, such that the instructions stored in the computer-readable memory produce a wireless terminal including instructions which implement the function specified in the block diagram and/or flowchart block or blocks.

The computer program instructions may also be loaded in a wireless terminal to cause a series of operational steps to be performed, to produce a process or method such that the instructions which execute in the wireless terminal provide steps for implementing the functions specified in the block diagram and/or flowchart block or blocks. Moreover, unless indicated to the contrary, operational steps need not be performed in the order that is illustrated.

In the drawings and specification, there have been disclosed typical preferred embodiments of the invention and, although specific terms are employed, they are used in a generic and descriptive sense only and not for purposes of limitation, the scope of the invention being set forth in the following claims.

1. A method of operating a multiple-mode Advanced Mobile Phone Service (AMPS) system/Code Division Multiple Access (CDMA) system wireless terminal comprising:
attempting to acquire the CDMA system at the multiple-mode AMPS/CDMA wireless terminal independent of receiving a Global Action (GA) overhead message from the AMPS system at the multiple-mode AMPS/CDMA wireless terminal, while continuing to receive paging messages for the multiple-mode AMPS/CDMA wireless terminal from the AMPS system.

2. The method according to claim 1 wherein the attempting to acquire the CDMA system at the multiple-mode AMPS/CDMA wireless terminal independent of receiving a Global Action (GA) overhead message from the AMPS system at the multiple-mode AMPS/CDMA wireless terminal, while continuing to receive paging messages for the multiple-mode AMPS/CDMA wireless terminal from the AMPS system is followed by:
transitioning the multiple-mode AMPS/CDMA wireless terminal from the AMPS system to the CDMA system in response to the attempting to acquire the CDMA system at the multiple-mode AMPS/CDMA wireless terminal independent of receiving a Global Action (GA) overhead message from the AMPS system at the multiple-mode AMPS/CDMA wireless terminal, while continuing to receive paging messages for the multiple-mode AMPS/CDMA wireless terminal from the AMPS system being successful.

3. The method according to claim 1 wherein the attempting to acquire the CDMA system at the multiple-mode AMPS/CDMA wireless terminal independent of receiving a Global Action (GA) overhead message from the AMPS system at the multiple-mode AMPS/CDMA wireless terminal, while continuing to receive paging messages for the multiple-mode AMPS/CDMA wireless terminal from the AMPS system comprises:
receiving paging messages for the multiple-mode AMPS/CDMA wireless terminal from the AMPS system at the multiple-mode AMPS/CDMA wireless terminal during spaced apart time intervals; and
attempting to acquire the CDMA system at the multiple-mode AMPS/CDMA wireless terminal between the spaced apart time intervals.

4. The method according to claim 3:
wherein the receiving paging messages for the multiple-mode AMPS/CDMA wireless terminal from the AMPS system at the multiple-mode AMPS/CDMA wireless terminal during spaced apart time intervals comprises:
receiving a paging message from a first frame of an AMPS control channel of the AMPS system at the multiple-mode AMPS/CDMA wireless terminal;
entering an AMPS sleep mode after the receiving a paging message from the first frame of an AMPS control channel of the AMPS system at the multiple-mode AMPS/CDMA wireless terminal; and
wherein the attempting to acquire the CDMA system at the multiple-mode AMPS/CDMA wireless terminal between the spaced apart time intervals comprises accumulating CDMA pilot acquisition data during the AMPS sleep mode;
the method further comprising repeating the receiving a paging message from a first frame of an AMPS control channel of the AMPS system at the multiple-mode AMPS/CDMA wireless terminal, the entering an AMPS sleep mode after the receiving a paging message from a first frame of an AMPS control channel of the AMPS system at the multiple-mode AMPS/CDMA wireless terminal and the accumulating CDMA pilot acquisition data during the AMPS sleep mode, for second and subsequent frames of the AMPS control channel of the AMPS system.

5. The method according to claim 4 wherein the repeating the receiving a paging message from a first frame of an AMPS control channel of the AMPS system at the multiple-mode AMPS/CDMA wireless terminal, the entering an AMPS sleep mode after the receiving a paging message from a first frame of an AMPS control channel of the AMPS system at the multiple-mode AMPS/CDMA wireless terminal and the accumulating CDMA pilot acquisition data during the AMPS sleep mode, for second and subsequent frames of the AMPS control channel of the AMPS system, is performed until sufficient CDMA pilot acquisition data is accumulated to acquire the CDMA pilot.

6. The method according to claim 5 wherein the following is performed after the repeating the receiving a paging message from a first frame of an AMPS control channel of the AMPS system at the multiple-mode AMPS/CDMA wireless terminal, the entering an AMPS sleep mode after the receiving a paging message from a first frame of an AMPS control channel of the AMPS system at the multiple-mode AMPS/CDMA wireless terminal and the accumulating CDMA pilot acquisition data during the AMPS sleep mode, for second and subsequent frames of the AMPS control channel of the AMPS system is performed until sufficient CDMA pilot acquisition data is accumulated to acquire the CDMA pilot:
terminating the receiving paging messages for the multiple-mode AMPS/CDMA wireless terminal from the AMPS system at the multiple-mode AMPS/CDMA wireless terminal during the spaced apart time intervals, in response to the sufficient CDMA pilot acquisition data being accumulated to acquire the CDMA pilot.

7. The method according to claim 4 wherein the repeating the receiving a paging message from a first frame of an AMPS control channel of the AMPS system at the multiple-mode AMPS/CDMA wireless terminal, the entering an AMPS sleep mode after the receiving a paging message from a first frame of an AMPS control channel of the AMPS system at the multiple-mode AMPS/CDMA wireless terminal and the accumulating CDMA pilot acquisition data during the AMPS sleep mode, for second and subsequent frames of the AMPS control channel of the AMPS system, is performed until sufficient CDMA pilot acquisition data is accumulated to acquire the CDMA pilot and a CDMA System ID (SID) field.

8. The method according to claim 7 wherein the following is performed after the repeating the receiving a paging message from a first frame of an AMPS control channel of the AMPS system at the multiple-mode AMPS/CDMA wireless terminal, the entering an AMPS sleep mode after the receiving a paging message from a first frame of an AMPS control channel of the AMPS system at the multiple-mode AMPS/CDMA wireless terminal and the accumulating CDMA pilot acquisition data during the AMPS sleep mode, for second and subsequent frames of the AMPS control channel of the AMPS system is performed until sufficient CDMA pilot acquisition data is accumulated to acquire the CDMA pilot and a CDMA System ID (SID) field:
terminating the receiving paging messages for the multiple-mode AMPS/CDMA wireless terminal from the AMPS system at the multiple-mode AMPS/CDMA wireless terminal during spaced apart time intervals in response to sufficient CDMA pilot acquisition data being accumulated to acquire the CDMA pilot and a CDMA System ID (SID) field.

9. The method according to claim 4 wherein following is performed after the repeating the receiving a paging message from a first frame of an AMPS control channel of the AMPS system at the multiple-mode AMPS/CDMA wireless terminal, the entering an AMPS sleep mode after the receiving a paging message from a first frame of an AMPS control channel of the AMPS system at the multiple-mode AMPS/CDMA wireless terminal and the accumulating CDMA pilot acquisition data during the AMPS sleep mode, for second and subsequent frames of the AMPS control channel of the AMPS system is performed until sufficient CDMA pilot acquisition data is accumulated to acquire the CDMA pilot and a CDMA System ID (SID) field:
error correcting the CDMA SID field.

10. The method according to claim 1 wherein the attempting to acquire the CDMA system at the multiple-mode AMPS/CDMA wireless terminal independent of receiving a Global Action (GA) overhead message from the AMPS system at the multiple-mode AMPS/CDMA wireless terminal, while continuing to receive paging messages for the multiple-mode AMPS/CDMA wireless terminal from the AMPS system is repeatedly performed during spaced apart time intervals.

11. The method according to claim 1 wherein the attempting to acquire the CDMA system at the multiple-mode AMPS/CDMA wireless terminal independent of receiving a Global Action (GA) overhead message from the AMPS system at the multiple-mode AMPS/CDMA wireless terminal, while continuing to receive paging messages for the multiple-mode AMPS/CDMA wireless terminal from the AMPS system is repeatedly performed during increasingly spaced apart time intervals.

12. A method of operating a multiple-mode Advanced Mobile Phone Service (AMPS) system/Code Division Multiple Access (CDMA) system wireless terminal comprising:
receiving paging messages for the multiple-mode AMPS/CDMA wireless terminal from the AMPS system at the multiple-mode AMPS/CDMA wireless terminal during spaced apart time intervals; and
attempting to acquire the CDMA system at the multiple-mode AMPS/CDMA wireless terminal between the spaced apart time intervals.

13. The method according to claim 12:
wherein the receiving paging messages for the multiple-mode AMPS/CDMA wireless terminal from the AMPS system at the multiple-mode AMPS/CDMA wireless terminal during spaced apart time intervals comprises:
receiving a paging message from a first frame of an AMPS control channel of the AMPS system at the multiple-mode AMPS/CDMA wireless terminal; and
entering an AMPS sleep mode after the receiving a paging message from a first frame of an AMPS control channel of the AMPS system at the multiple-mode AMPS/CDMA wireless terminal; and
wherein the attempting to acquire the CDMA system at the multiple-mode AMPS/CDMA wireless terminal between the spaced apart time intervals comprises accumulating CDMA pilot acquisition data during the AMPS sleep mode;
the method further comprising repeating the receiving a paging message from a first frame of an AMPS control channel of the AMPS system at the multiple-mode AMPS/CDMA wireless terminal, the entering an AMPS sleep mode after the receiving a paging message from a first frame of an AMPS control channel of the AMPS system at the multiple-mode AMPS/CDMA wireless terminal and the accumulating CDMA pilot acquisition data during the AMPS sleep mode, for second and subsequent frames of the AMPS control channel of the AMPS system.

14. The method according to claim 13 wherein the repeating the receiving a paging message from a first frame of an AMPS control channel of the AMPS system at the multiple-mode AMPS/CDMA wireless terminal, the entering an AMPS sleep mode after the receiving a paging message from a first frame of an AMPS control channel of the AMPS system at the multiple-mode AMPS/CDMA wireless terminal and the accumulating CDMA pilot acquisition data during the AMPS sleep mode, for second and subsequent frames of the AMPS control channel of the AMPS system is performed until sufficient CDMA pilot acquisition data is accumulated to acquire the CDMA pilot.

15. The method according to claim 14 wherein the following is performed after the repeating the receiving a paging message from a first frame of an AMPS control channel of the AMPS system at the multiple-mode AMPS/CDMA wireless terminal, the entering an AMPS sleep mode after the receiving a paging message from a first frame of an AMPS control channel of the AMPS system at the multiple-mode AMPS/CDMA wireless terminal and the accumulating CDMA pilot acquisition data during the AMPS sleep mode, for second and subsequent frames of the AMPS control channel of the AMPS system is performed until sufficient CDMA pilot acquisition data is accumulated to acquire the CDMA pilot:
terminating the receiving paging messages for the multiple-mode AMPS/CDMA wireless terminal from the AMPS system at the multiple-mode AMPS/CDMA wireless terminal during spaced apart time intervals, in response to the sufficient CDMA pilot acquisition data being accumulated to acquire the CDMA pilot.

16. The method according to claim 13 wherein the repeating the receiving a paging message from a first frame of an AMPS control channel of the AMPS system at the multiple-mode AMPS/CDMA wireless terminal, the entering an AMPS sleep mode after the receiving a paging message from a first frame of an AMPS control channel of the AMPS system at the multiple-mode AMPS/CDMA wireless terminal and the accumulating CDMA pilot acquisition data during the AMPS sleep mode, for second and subsequent frames of the AMPS control channel of the AMPS system is performed until sufficient CDMA pilot acquisition data is accumulated to acquire the CDMA pilot and a CDMA System ID (SID) field.

17. The method according to claim 16 wherein the following is performed after the repeating the receiving a paging message from a first frame of an AMPS control channel of the AMPS system at the multiple-mode AMPS/CDMA wireless terminal, the entering an AMPS sleep mode after the receiving a paging message from a first frame of an AMPS control channel of the AMPS system at the multiple-mode AMPS/CDMA wireless terminal and the accumulating CDMA pilot acquisition data during the AMPS sleep mode, for second and subsequent frames of the AMPS control channel of the AMPS system is performed until sufficient CDMA pilot acquisition data is accumulated to acquire the CDMA pilot and a CDMA System ID (SID) field:
terminating the receiving paging messages for the multiple-mode AMPS/CDMA wireless terminal from the AMPS system at the multiple-mode AMPS/CDMA wireless terminal during spaced apart time intervals, in response to the sufficient CDMA pilot acquisition data being accumulated to acquire the CDMA pilot and a CDMA System ID (SID) field.

18. The method according to claim 16 wherein the following is performed after the repeating the receiving a paging message from a first frame of an AMPS control channel of the AMPS system at the multiple-mode AMPS/CDMA wireless terminal, the entering an AMPS sleep mode after the receiving a paging message from a first frame of an AMPS control channel of the AMPS system at the multiple-mode AMPS/CDMA wireless terminal and the accumulating CDMA pilot acquisition data during the AMPS sleep mode, for second and subsequent frames of the AMPS control channel of the AMPS system is performed until sufficient CDMA pilot acquisition data is accumulated to acquire the CDMA pilot and a CDMA System ID (SID) field:
error correcting the CDMA SID field.

19. The method according to claim 12 wherein the receiving paging messages for the multiple-mode AMPS/CDMA wireless terminal from the AMPS system at the multiple-mode AMPS/CDMA wireless terminal during spaced apart time intervals is repeatedly performed during increasingly spaced apart time intervals.

20. A multiple-mode wireless terminal comprising:
an Advanced Mobile Phone Service (AMPS) subsystem that is configured to communicate with an AMPS wireless communications system;
a Code Division Multiple Access (CDMA) subsystem that is configured to communicate with a CDMA wireless communications system; and
a controller that is configured to control the AMPS subsystem and the CDMA subsystem to attempt to acquire the CDMA system independent of receiving a Global Action (GA) overhead message from the AMPS system, while continuing to receive paging messages for the multiple-mode AMPS/CDMA wireless terminal from the AMPS system.

21. The multiple-mode wireless terminal according to claim 20 wherein the controller is further configured to control the AMPS subsystem and the CDMA subsystem to transition the multiple-mode AMPS/CDMA wireless terminal from the AMPS system to the CDMA system in response to the attempt to acquire the CDMA system independent of receiving a Global Action (GA) overhead message from the AMPS system, while continuing to receive paging messages for the multiple-mode AMPS/CDMA wireless terminal from the AMPS system being successful.

22. The multiple-mode wireless terminal according to claim 20 wherein the controller is further configured to control the AMPS subsystem and the CDMA subsystem to receive paging messages for the multiple-mode AMPS/CDMA wireless terminal from the AMPS system during spaced apart time intervals, and to attempt to acquire the CDMA system between the spaced apart time intervals.

23. The multiple-mode wireless terminal according to claim 20 wherein the controller is further configured to control the AMPS subsystem and the CDMA subsystem to receive a paging message from a first frame of an AMPS control channel of the AMPS system, to enter an AMPS sleep mode after receiving the paging message from the first frame, to accumulate CDMA pilot acquisition data during the AMPS sleep mode and to repeat the receiving a paging message, the entering an AMPS sleep mode and the accumulating CDMA pilot acquisition data during the AMPS sleep mode, for second and subsequent frames of the AMPS control channel of the AMPS system.

24. The multiple-mode wireless terminal according to claim 23 wherein the controller is further configured to control the AMPS subsystem and the CDMA subsystem to repeat the receiving a paging message, the entering an AMPS sleep mode and the accumulating CDMA pilot acquisition data during the AMPS sleep mode, for second and subsequent frames of the AMPS control channel of the AMPS system until sufficient CDMA pilot acquisition data is accumulated to acquire the CDMA pilot.

25. The multiple-mode wireless terminal according to claim 23 wherein the controller is further configured to control the AMPS subsystem and the CDMA subsystem to terminate the receiving paging messages from the AMPS system during the spaced apart time intervals in response to the sufficient CDMA pilot acquisition data being accumulated to acquire the CDMA pilot.

26. The multiple-mode wireless terminal according to claim 23 wherein the controller is further configured to control the AMPS subsystem and the CDMA subsystem to repeat the receiving a paging message, the entering an AMPS sleep mode and the accumulating CDMA pilot acquisition data during the AMPS sleep mode, for second and subsequent frames of the AMPS control channel of the AMPS system until sufficient CDMA pilot acquisition data is accumulated to acquire the CDMA pilot and a CDMA System ID (SID) field.

27. The multiple-mode wireless terminal according to claim 26 wherein the controller is further configured to control the AMPS subsystem and the CDMA subsystem to terminate the receiving paging messages from the AMPS system during the spaced apart time intervals in response to the sufficient CDMA pilot acquisition data being accumulated to acquire the CDMA pilot and the CDMA SID field.

28. The multiple-mode wireless terminal according to claim 26 wherein the controller is further configured to error correct the CDMA SID field.

29. The multiple-mode wireless terminal according to claim 20 wherein the controller is further configured to control the AMPS subsystem and the CDMA subsystem to attempt to acquire the CDMA system during spaced apart time intervals.

30. The multiple-mode wireless terminal according to claim 20 wherein the controller is further configured to control the AMPS subsystem and the CDMA subsystem to attempt to acquire the CDMA system during increasingly spaced apart time intervals.

31. A multiple-mode wireless terminal comprising:
an Advanced Mobile Phone Service (AMPS) subsystem that is configured to communicate with an AMPS wireless communications system;
a Code Division Multiple Access (CDMA) subsystem that is configured to communicate with a CDMA wireless communications system; and
a controller that is configured to control the AMPS subsystem and the CDMA subsystem to receive paging messages for the multiple-mode AMPS/CDMA wireless terminal from the AMPS system during spaced apart time intervals, and to attempt to acquire the CDMA system between the spaced apart time intervals.

32. The multiple-mode wireless terminal according to claim 31 wherein the controller is further configured to control the AMPS subsystem and the CDMA subsystem to receive a paging message from a first frame of an AMPS control channel of the AMPS system, to enter an AMPS sleep mode after receiving the paging message from the first frame, to accumulate CDMA pilot acquisition data during the AMPS sleep mode and to repeat the receiving a paging message, the entering an AMPS sleep mode and the accumulating CDMA pilot acquisition data during the AMPS sleep mode, for second and subsequent frames of the AMPS control channel of the AMPS system.

33. The multiple-mode wireless terminal according to claim 31 wherein the controller is further configured to control the AMPS subsystem and the CDMA subsystem to receive a paging message from a first frame of an AMPS control channel of the AMPS system, to enter an AMPS sleep mode after receiving the paging message from the first frame, to accumulate CDMA pilot acquisition data during the AMPS sleep mode and to repeat the receiving a paging message, the entering an AMPS sleep mode and the accumulating CDMA pilot acquisition data during the AMPS sleep mode, for second and subsequent frames of the AMPS control channel of the AMPS system until sufficient CDMA pilot acquisition data is accumulated to acquire the CDMA pilot.

34. The multiple-mode wireless terminal according to claim 31 wherein the controller is further configured to control the AMPS subsystem and the CDMA subsystem to receive a paging message from a first frame of an AMPS control channel of the AMPS system, to enter an AMPS sleep mode after receiving the paging message from the first frame, to accumulate CDMA pilot acquisition data during the AMPS sleep mode and to repeat the receiving a paging message, the entering an AMPS sleep mode and the accumulating CDMA pilot acquisition data during the AMPS sleep mode, for second and subsequent frames of the AMPS control channel of the AMPS system until sufficient CDMA pilot acquisition data is accumulated to acquire the CDMA pilot and a CDMA System ID (SID) field.

35. The multiple-mode wireless terminal according to claim 33 wherein the controller is further configured to control the AMPS subsystem and the CDMA subsystem to terminate the receiving paging messages from the AMPS system in response to the sufficient CDMA pilot acquisition data being accumulated to acquire the CDMA pilot.

36. The multiple-mode wireless terminal according to claim 34 wherein the controller is further configured to control the AMPS subsystem and the CDMA subsystem to terminate the receiving paging messages from the AMPS system in response to the sufficient CDMA pilot acquisition data being accumulated to acquire the CDMA pilot and the CDMA SID field.

37. The multiple-mode wireless terminal according to claim 34 wherein the controller is further configured to error correct the CDMA SID field.

38. The multiple-mode wireless terminal according to claim 31 wherein the controller is further configured to control the AMPS subsystem and the CDMA subsystem to attempt to acquire the CDMA system at increasingly spaced apart time intervals.
